(19) United States
(12) Patent Application Publication
(10) Pub. No.: US 2004/0079179 A1
(43) Pub. Date: Apr. 29, 2004

(54) Slip clutch for starter drive

(75) Inventor: Johann Holzleitner, Gunskirchen (AT)

Correspondence Address: PILLSBURY WINTHROP, LLP, P.O. BOX 10500, MCLEAN, VA, 22102, US

(73) Assignee: Bombardier-Rotax GmbH & Co. K.G., Gunskirchen (AT)

(21) Appl. No.: 10/690,549

(22) Filed: Oct. 23, 2003

Related U.S. Application Data
(60) Provisional application No. 60/420,258, filed on Oct. 23, 2002.

(51) Int. Cl. F02N 1/00

(52) U.S. Cl. 74/7 B

(57) ABSTRACT

A starter assembly for an internal combustion is described. The starter assembly has a starter motor with a rotatable output shaft. An intermediate shaft transmits rotational motion between the output shaft and the crankshaft. A first gear is connected operatively between the output shaft and the intermediate shaft to transmit rotational motion therebetween. A friction-plate clutch is associated with the first gear and is constructed and arranged to operatively decouple the first gear from the intermediate shaft in response to torque shocks from the engine that exceed a predetermined threshold. A second gear is connected operatively between the intermediate shaft and at least a third gear that is operatively connected to the crankshaft. The second gear transmits rotational motion between the intermediate shaft and the third gear. A clutch is associated with the second gear permitting selective decoupling of the second gear from the third gear.

### CROSS-REFERENCE TO RELATED APPLICATION(S)

This application relies for priority on U.S. Provisional Patent Application Serial No. 60/420,258, entitled “Slip Clutch for Starter Drive,” filed on Oct. 23, 2002, the content of which are incorporated herein by reference.

### BACKGROUND OF THE INVENTION

1. Field of the Invention

The present invention relates to a starter assembly for an internal combustion engine.

2. Description of the Related Art

Relatively large torque shocks typically occur during the starting operation of an internal combustion engine. Particularly in the case of large-capacity engines with a small number of cylinders, these shocks can destroy the starter gearing, in particular the starter pinion attached to the starter motor. Such torque shocks may be generated, for example in the event of pre-ignition within one or more of the cylinders in the internal combustion engine. They also may be generated when starting an engine that may be operated in both a forward-running and a backward-running operation, especially in an engine designed to alter its operation by transitioning from a forward-running to a backward-running condition.

Japanese Patent No. JP 63-005160 describes a starting device in which torque shocks of this kind are absorbed by a friction clutch that is arranged inside the starter housing. The friction clutch includes multiple plates and connects the drive shaft of the starter motor to the starter pinion. One disadvantage of this particular arrangement is that the starter motor has a relatively large length, which makes the starter motor more difficult to incorporate into certain engine types. Moreover, since the friction clutch is integrated into the starter motor housing, it cannot be used for other types of starter motors.

U.S. Pat. No. 4,192,195 describes a starting device with an absorber that smoothes out torque shocks between the starter motor and the starter pinion. In this prior art starting device, the pinion shaft is connected to the starter motor in such a way that it can slide along a helical shaft connection, through an overriding clutch.

U.S. Pat. No. 6,239,503 discloses an electric starting device in which the starter motor is connected to the starter pinion through epicyclic gearing. An internally-toothed annulus is mounted within a ring so as to be able to slide therein. The ring incorporates stops to limit rotary movement of the annulus. In normal operation, the internally toothed annulus is secured by the ring so that the pinion shaft is driven by the starter motor through the sun wheel and the planetary pinions. If torque shocks occur, the annulus of the planetary gearing slides within the ring, to that torque peaks are intercepted and diffused. Disadvantages of this design lie in the fact that it is relatively costly and requires a great deal of space for its installation.

German Patent No. DE 37 11 430 A1 describes a manual cranking device for internal combustion engines, which provides protection against kickbacks. In this apparatus, shaft sections of the drive shaft are coupled non-positively through a sliding clutch that can be adjusted for torque. The sliding clutch comprises a clutch plate that is installed on a shaft section so as to rotate in unison with it. This clutch plate forms clutch surfaces on its opposing radial annular surfaces, a matching clutch surface being associated with each of these, with a friction lining being interposed between them. The transmitted torque may be adjusted by pressing the clutch disk against the friction lining. A disadvantage with this arrangement is that the sliding clutch requires a relatively large amount of space for its operation. Moreover, it is not suitable for electric starting devices.

Japanese Published Patent Applications Nos. JP 4159455, JP 7083147, JP 61283762 and JP 61282644 each disclose starter arrangements of a different principle where a freewheel clutch, disposed on the crankshaft, separates the starter from the crankshaft. The electric starter is coupled to the crankshaft via a torque limiter comprising a plurality of friction plates. The arrangement, however, has several disadvantages. First, it occupies a large amount of space. Second, it is expensive to manufacture. Third, the arrangement is unreliable.

U.S. Pat. No. 5,894,756 and published European Patent Application No. 1024283A2 both disclose bendix-type starter arrangements having intermediate shafts with a first gear on the intermediate shaft for transmitting torque to a second gear on the crankshaft. As disclosed in these two references, there is a helical spline provided on the intermediate shaft which is capable of moving the first gear with regard to the second gear, whereby a coupling and decoupling between the starter drive and the crankshaft can be established. In practice, these kind of starters are often destroyed by torque shocks.

Finally, other starter arrangements are also known where the starter motor is operatively connected to the crankshaft without a torque-shock-absorbing device associated therewith. In such prior art starter assemblies, it is not uncommon for the torque shocks generated by the engine to destroy the starter motor.

The prior art, therefore, fails to provide a simple, reliable, costeffective, space-efficient starter assembly for an internal combustion engine that minimizes (or significantly eliminates) transfer of torque shocks between the crankshaft and the starter motor.

### SUMMARY OF THE INVENTION

It is one aspect of the present invention to provide a starter assembly for an internal combustion engine that avoids the transfer of torque shocks between the starter motor and the crankshaft in the simplest and most space-saving manner possible.

To achieve this goal, among others, the present invention provides a starter assembly for an internal combustion. The starter assembly has a starter motor with a rotatable output shaft. An intermediate shaft transmits rotational motion between the output shaft and the crankshaft. A first gear is connected operatively between the output shaft and the intermediate shaft to transmit rotational motion therebetween. A friction-plate clutch is associated with the first gear and is constructed and arranged to operatively decouple the first gear from the intermediate shaft in response to torque shocks from the engine that exceed a predetermined threshold. A second gear is connected operatively between the intermediate shaft and at least a third gear that is operatively connected to the crankshaft. The second gear transmits rotational motion between the intermediate shaft and the third gear. A clutch is associated with the second gear permitting selective decoupling of the second gear from the third gear.

As presented herein, the present invention provides a starter assembly for an internal combustion engine with a starter motor that can be connected to a crankshaft by way of starter gearing. The starter gearing incorporates an intermediate shaft with a first starter pinion that is driven by the starter motor. The starter gearing also includes a second, driving, starter pinion that can be moved into engagement with a starter ring gear on the crankshaft. A friction clutch is arranged between the starter motor and the crankshaft to absorb torque shocks.

According to the present invention, to provide a starter assembly for an internal combustion engine that avoids the transfer of torque shocks between the starter motor and the crankshaft in the simplest and most space-saving manner possible, the sliding clutch is a friction disk clutch.

In particular, in one embodiment, the sliding clutch is a single-plate friction disk clutch. The first gear wheel of the clutch is connected to the intermediate shaft so as to rotate in unison with it. The sliding clutch provides a nonpositive rotational joint between the first gear wheel and the intermediate shaft. The rotational joint is separable once a predetermined torque shock is exceeded. The sliding clutch reduces the transmitted torque to the point that it will not damage the drive components. Space requirements are kept small enough that it may be adapted to existing designs and also may be retrofitted to them. In the simplest case, adaptation is possible because only the first gear wheel has to be replaced. The remaining parts of the intermediate gearing may remain unchanged.

In one particularly space-saving variant, provision is made such that the sliding clutch has a spring-loaded driving disk that is connected positively to the intermediate shaft.

Alternatively, the sliding clutch has a spring-loaded driving disk with a hub that is connected positively to intermediate shaft and non-positively to the first gear wheel.

In still another alternative, provision also may be made such that the sliding clutch has a spring loaded driving disk that is connected positively to the first gear wheel and non-positively to the intermediate shaft.

Alternatively, the sliding clutch may have a spring loaded driving disk that is connected positively to a hub that is connected rigidly to the intermediate shaft. When this is done, it is preferred that provision be made such that the non-positive connection be effected by a spring—preferably a disk spring—that acts axially on the driving disk. Thus, the number of separate parts can be kept to a minimum.

A very compact variant may be achieved if the positive connection is formed by at least one axial groove in the hub that functions in conjunction with a corresponding extension or protrusion on the driving disk.

In another variant of the present invention, provision is made such that the driving disk has a driving surface on the face that is remote from the spring. The driving surface is pressed by the spring against a face of the first gear wheel.

Even more space can be saved if the first gear wheel is configured as a gear ring that is mounted on the intermediate shaft so as to be able to rotate thereon.

Further aspects of the present invention may be appreciated by the drawings appended hereto and the description of the preferred embodiments that follows.

### BRIEF DESCRIPTION OF THE DRAWINGS

The present invention will be described in greater detail below on the basis of the drawings appended hereto, wherein:

FIG. 1 is a cross-sectional side view of the starter assembly according to the present invention;

FIG. 2 is a cross-sectional side view of a hub portion of the starter assembly illustrated in FIG. 1;

FIG. 3 is plan view of the driving disk of the starter assembly illustrated in FIG. 1; and

FIG. 4 is a cross-sectional side view of the driving disk illustrated in FIG. 3.

Where appropriate, like reference numerals are employed to designate like items throughout the drawings.

### DESCRIPTION OF THE PREFERRED EMBODIMENT(S)

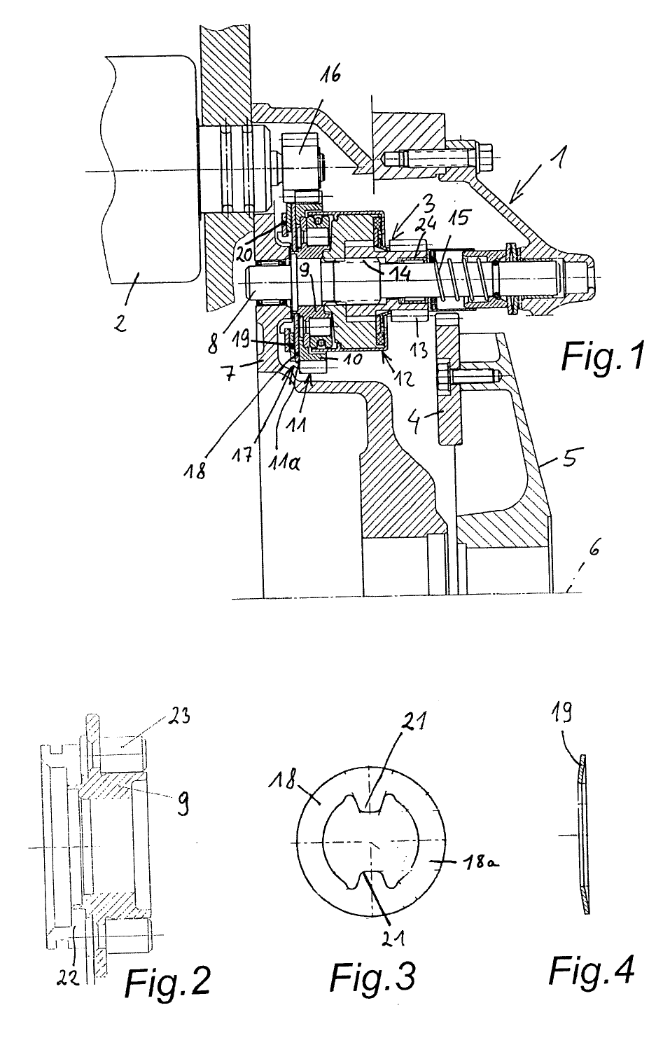

FIG. 1 is a cross-sectional side view of one embodiment of the starter assembly 1 of the present invention. It is contemplated that the starter assembly 1 will be employed in conjunction with an internal combustion engine, which is not illustrated in the drawings.

The starter assembly 1 includes a starter motor 2 that engages with a starter ring gear 4 through starter gearing 3. The starter ring gear 4 is connected rigidly to a disk that is part of a crankshaft, which is not illustrated. While the crankshaft is not illustrated, the axis of the crankshaft bears the reference number 6.

The starter gearing 3 includes an intermediate shaft 8 that is supported in the housing 7 of the internal combustion engine. The starter gearing 8 also has a hub 9 that is pressed onto the intermediate shaft 7. However, the hub can be rigidly fixed onto the intermediate shaft by another appropriate method, as would be appreciated by those skilled in the art.

A first gear wheel 11, which is formed by a gear ring 10, is arranged on the hub 9. The first gear wheel 11 is rotatable relative to the hub 9. The gear ring 10 of the first gear wheel 11 is connected to the hub 9 through a plain bearing.

In addition, the starter gearing 3 incorporates a contact element 12 with a second gear wheel 13. The contact element 12 is connected to the intermediate shaft 8 through a helical groove or helical spline, so that the contact element 12, together with the second gear wheel 13, can be shifted axially relative to the intermediate shaft 8, between an initial position and an engaged position as soon as there is relative movement between the intermediate shaft 8 and the contact element 12. When this occurs, the compression spring 15 acts on the contact element 12 axially, applying a force in the direction of the initial position of the contact element 12 (which is shown in FIG. 1).

The starter pinion 16 of the starter motor 2 is constantly engaged with the first gear wheel 11.

The first gear wheel 11 is connected non-positively to the hub 9 through a sliding clutch 17. The sliding clutch 17 is essentially a single-plate clutch and has a driving disk 18 that is pressed against a face 11a of the first gear wheel 11 by a disk spring 19. A driving surface 18a of the driving disk 18, which is arranged on the side that is remote from the spring 19, thus acts on the face 11a of the first gear wheel 11 so that a non-positive rotational connection is established between the first gear wheel 11 and the hub 9. The disk spring 19 that is shown in FIG. 4 rests against a safety ring 20 that is connected rigidly to the hub 9. As FIG. 3 shows, the driving disk 18 has projections 21 that engage in corresponding axial grooves 22 in the hub 9, thereby forming a positive connection between the driving disk 18 and the hub 9. Since the driving disk does not directly engage the intermediate shaft and the friction clutch connects to the hub, the fatigue resistance of the intermediate shaft is not deteriorated.

FIG. 2 illustrates the cross-section of the hub 9. FIG. 2 also shows the attachment rivets 23 of the hub 9.

When the starter motor 2 is activated during the start-up operation, the starter pinion 16 causes the first gear wheel 11 that is non-positively connected to the intermediate shaft 8 to rotate. Because of the inertia of the contact element 12 and of the second gear wheel 13, there will be relative rotation between the intermediate shaft 8 and the contact element 12 so that the second gear wheel 13 is displaced against the force exerted by the spring 15, out of the initial position, axially along the helical groove 14 (which is to say, to the right in FIG. 1), and into the engaged position. In the engaged position, the second gear wheel 13 meshes with the starter ring gear 4, so that a drive connection is established between the starter motor 2 and the crankshaft.

The second gear wheel 13 is connected to the contact element 12 or the intermediate shaft 8 through an overriding clutch 24. If the internal combustion engine starts, the starter ring gear 4 will rotate faster than the second gear wheel 13, so that the second gear wheel 13 is driven by the starter ring gear 4 in the freewheeling direction. The result of this is that the contact element 12 together with the second gear wheel 13 is displaced along the helical groove, back into its initial position, and this concludes the starting process.

In exceptional cases, for instance, as a result of the internal combustion engine kick-back, this can cause torque shocks between the starter motor 2 and the crankshaft, and these torque shocks could damage parts of the starter assembly 1. Such torque shocks are effectively absorbed by the overriding clutch 17, since above a predetermined torque, the driving disk 18 and the first gear wheel 11 slide relative to each other in the direction of rotation, so that torque peaks are smoothed out.

It is contemplated that there are several embodiments of the starter assembly 1 of the present invention that are encompassed by the description and drawings provided herein. In one embodiment, which is illustrated in FIGS. 1-4, the driving disk 18 is positively connected to the hub 9 via interaction between the projections 21 on the driving disk 18 and the groove 22 on the hub 9. As a result, in this embodiment, the driving disk 18 is positively connected to the intermediate shaft 8 via the hub 9.

In another embodiment, it is contemplated that the driving disk 18 may be connected directly to the intermediate shaft 8. If so, the projections 21 on the driving disk 18 would engage grooves in the intermediate shaft 8. In this embodiment, the first gear wheel 11 would be rotationally mounted on the intermediate shaft 8 via a connection other than the hub 9, as illustrated in FIG. 1.

In still another embodiment, it is contemplated that the driving disk 18 may be positively connected to the first gear wheel 11 and non-positively connected to the hub 9. In this embodiment, when a predetermined torque shock is exceeded, the driving disk 18 slips with respect to the hub 9.

In one further embodiment, the driving disk 18 may be positively connected to the first gear wheel 11 and non-positively connected to the intermediate shaft 18. In this embodiment, the hub 9 is omitted.

For purposes of understanding the terminology used herein, the terms “positively” and “non-positively” are now defined. A “positive” connection is meant to encompass a rigid connection, which may be made by fastening two elements together, either via a fastener, such as a screw or a rivet, or via welding. These “positive” connections are meant only to be illustrative of the different types of positive connections that may be made between two elements.

A “non-positive” connection is meant to refer to a non-rigid connection between two elements, one where the two components are operatively connected. In the context of the present invention, a non-positive connection is mean to encompass a connection where rotational motion is transferred between two components under certain operational conditions but is not transferred between the components under other operational conditions.

It is contemplated that still other variations and embodiments of the present invention may be appreciated by those skilled in the art upon reading and understanding the instant disclosure. Those variants and embodiments are also intended to fall within the scope of the claims appended hereto.

What is claimed is:

1. A starter assembly for an internal combustion engine having a crankshaft, the starter assembly comprising:
a starter motor, the starter motor having an output shaft capable of rotational motion;
an intermediate shaft for transmitting rotational motion between the output shaft and the crankshaft;
a first gear operatively connected between the output shaft and the intermediate shaft to transmit rotational motion between the output shaft and the intermediate shaft;
a friction-plate clutch associated with the first gear, the friction plate clutch constructed and arranged to operatively decouple the first gear from the intermediate shaft in response to torque shocks from the engine that exceed a predetermined threshold;
a second gear operatively connected between the intermediate shaft and at least a third gear, the third gear being operatively connected to the crankshaft, the second gear transmitting rotational motion between the intermediate shaft and the third gear; and
a clutch associated with the second gear permitting selective decoupling of the second gear from the third gear.

2. The starter assembly of claim 1, wherein the second gear axially moves on the intermediate shaft between a first position where the second gear is operatively coupled to the third gear and a second position where the second gear is operatively decoupled from the third gear.

3. The starter assembly of claim 1, wherein the friction-plate clutch forms a non-positive connection between the first gear and the intermediate shaft.

4. The starter assembly of claim 1, wherein the first gear and the second gear are both disposed on the intermediate shaft at positions axially offset from one another.

5. The starter assembly of claim 1, wherein the friction-plate clutch further comprises:
at least one driving disk connected positively to the intermediate shaft and connected non-positively to the first gear.

6. The starter assembly of claim 5, wherein the friction-plate clutch further comprises:
a hub disposed between the driving disk and the intermediate shaft, positively connecting the driving disk to the intermediate shaft.

7. The starter assembly of claim 5, further comprising:
a spring disposed adjacent to the driving disk, wherein the spring axially presses the driving disk against the first gear to non-positively connect the driving disk to the first gear.

8. The starter assembly of claim 7, wherein the spring is a disk spring.

9. The starter assembly of claim 6, wherein the hub defines at least one axial groove therein and the driving disk includes at least one projection thereon, the at least one projection positively connecting the driving disk to the hub through interaction between the at least one projection and the groove.

10. The starter assembly of claim 7, wherein the driving disk comprises a driving surface and wherein, by operation of the spring, the driving surface is pressed against an adjacent surface of the first gear.

11. The starter assembly of claim 1, wherein the first gear is a ring gear mounted rotatably on the intermediate shaft.

12. The starter assembly of claim 11, further comprising:
a bearing disposed between the first gear and the intermediate shaft to facilitate rotation therebetween.

13. The starter assembly of claim 6, wherein the first gear is a ring gear mounted rotatably on the hub.

14. The starter assembly of claim 13, further comprising:
a bearing disposed between the first gear and the hub to facilitate rotation of the first gear with respect to the intermediate shaft.

15. The starter assembly of claim 1, wherein the friction-plate clutch further comprises:
at least one driving disk connected non-positively to the intermediate shaft and connected positively to the first gear.

16. The starter assembly of claim 15, wherein the friction-plate clutch further comprises:
a hub disposed between the driving disk and the intermediate shaft, non-positively connecting the driving disk to the intermediate shaft.

17. The starter assembly of claim 16, wherein the first gear is a ring gear mounted on the hub so as to rotate thereon.

18. The starter assembly of claim 17, further comprising:
a bearing disposed between the first gear and the hub to facilitate rotation of the first gear with respect to the intermediate shaft.

19. The starter assembly of claim 1, wherein a hub is provided on the intermediate shaft and connects the friction-plate clutch to the intermediate shaft.

20. The starter assembly of claim 19, wherein the hub is rigidly connected to the intermediate shaft.

21. The starter assembly of claim 1, wherein the second gear is disposed on the intermediate shaft on one side of the first gear and the friction-plate clutch is disposed on the intermediate shaft on an opposite side of the first gear.

22. The starter assembly of claim 21, wherein a hub is provided on the intermediate shaft and connects the friction-plate clutch to the intermediate shaft.

23. The starter assembly of claim 22, wherein the hub is rigidly connected to the intermediate shaft.
